(19) United States
(12) Patent Application Publication
(10) Pub. No.: US 2006/0037711 A1
(43) Pub. Date: Feb. 23, 2006

(54) Gluing device in a bottom laying device

(76) Inventors: Ruediger Duwendag, Lengerich (DE); Guido Kerres, Muenster (DE)

Correspondence Address: JACOBSON HOLMAN PLLC, 400 SEVENTH STREET N.W., SUITE 600, WASHINGTON, DC, 20004, US

(21) Appl. No.: 10/529,874

(22) PCT Filed: Nov. 26, 2003
(86) PCT No.: PCT/EP03/13312

§ 371 Date: Apr. 1, 2005

(30) Foreign Application Priority Data
Nov. 27, 2002 (DE) 102 55 486.2

(51) Int. Cl. B05C 1/02

(52) U.S. Cl. 156/578

(57) ABSTRACT

Disclosed is a bottom laying device for cross bottom bags (1) which are formed from tubular pieces (1). The bags pass through various processing stations inside the bottom laying device. The axis of the tubular pieces (1) during conveyance through said bottom laying device is oriented in a horizontal and orthogonal manner in respect to the direction of conveyance of said tubular pieces. The novel and inventive aspect of the device thus disclosed is that it enables further reduction of the dimensions of the middle of the bottom (A) without oversignificant reduction of the diameters of the counter press cylinders (7,7).

The invention relates to a bottoming device for cross bottom sacks according to the preamble of the patent claim 1.

Bottoming devices of this kind are known. In these devices, sacks and bags are manufactured from flat tube segments, of paper or plastic for instance, whose axes are oriented horizontally and orthogonal to the direction of the conveyance during the transport. For their manufacture, the ends of the tube segments are at first grooved and indented, the ends are then drawn up with formation of corner folds, whereby the ends are essentially perpendicular to the flat tube segments. Before joining the ends, the corner folds and the drawn up ends are spread with glue deposit, which results in thick gluing of these areas forming the bottom of the tube segment.

Such a device for spreading glue deposit according to format is known from DE 199 35 117 A1. This type of device comprises a function pair, consisting of a glue transfer roller, and each is provided with counter pressure rollers, arranged above and below the tube segment. The axes of all rollers lie vertical to the direction of conveyance of the glue segment. The areas of the tube segment to be glued pass through between the glue transfer rollers and the counterpressure rollers. Due to the contact pressure provided by the counterpressure rollers, the glue is transferred from the glue transfer roller to the corresponding regions of the tube segments.

If a bottom is to be formed at both the ends of the tube segments in the described manner, then the bottoming devices of the familiar construction types are provided with two similar processing stations lying mutually opposite.

However, what turns out thereby to be of a disadvantage is that, if the sacks are manufactured with a very small mean bottom size, which is determined by the height of the sack, the counterpressure rollers to be used must be accordingly smaller. The counterpressure rollers with a very small diameter may not be able to convey adequate counterpressure, however, because the counterpressure zone is smaller in accordance with the diameter. Therefore, in case of devices of the known types, the mean bottom size must not fall short of a certain minimum, a circumstance which limits the applicable range of the cross bottom bags that can be manufactured with such devices.

The task posed by the present invention lies in that a device be proposed which enables further reduction of the mean bottom size without reducing the diameter of the counterpressure rollers too much.

According to the invention, this task is solved by means of the features of the characterizing part of the claim 1.

According to that, the two function pairs, each consisting of a glue transfer roller and a counterpressure roller, are arranged with mutual displacement. With that, both the function pairs can be arranged at a small distance from each other and orthogonal to the direction of the conveyance.

In a preferred embodiment, at least one of the counterpressure rollers has a diameter, which is greater than half of the mean size of the bottom. By using such rollers, a sufficiently large counterpressure zone is provided.

It is more advantageous if the distance of the axes (determined by the connection of the roller axes of the glue transfer roller and the counterpressure roller) of the two function pairs in the direction of conveyance of the sacks is less than 50 cm. Such an arrangement ensures that despite the mutually displaced position of the function pair, a gluing of the areas of the tube segment that is as simultaneous as possible is ensured.

Further examples of the embodiments according to the invention follow from the concrete objective description and the claim. The individual figures show:

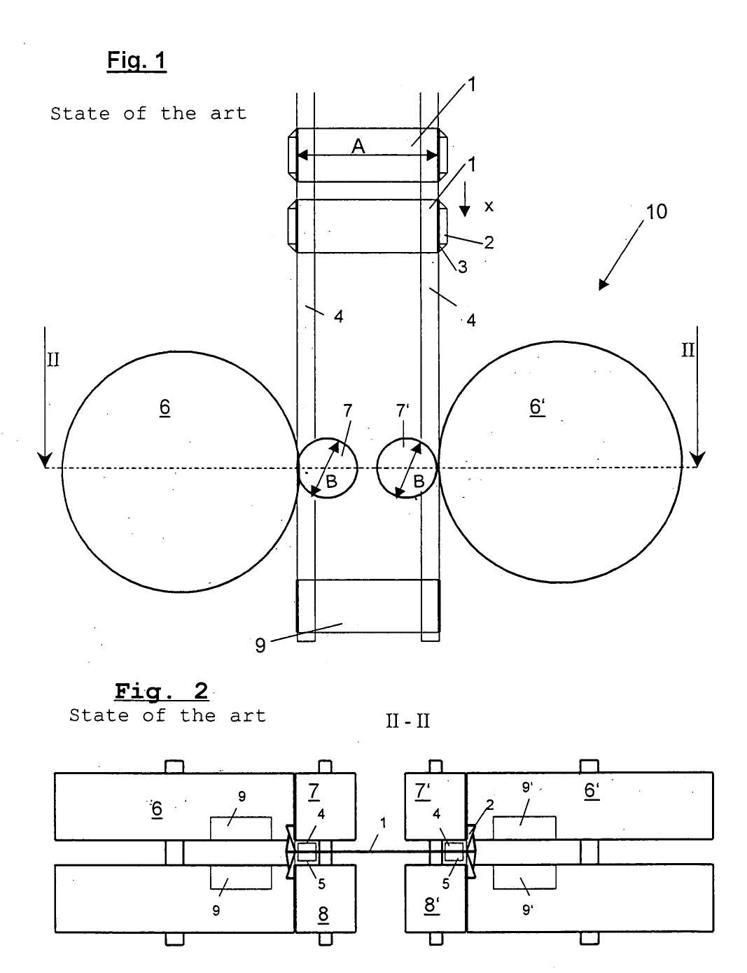

FIG. 1 Top view of a gluing station in a bottoming device of the known type

FIG. 2 View of the section II-II in FIG. 1

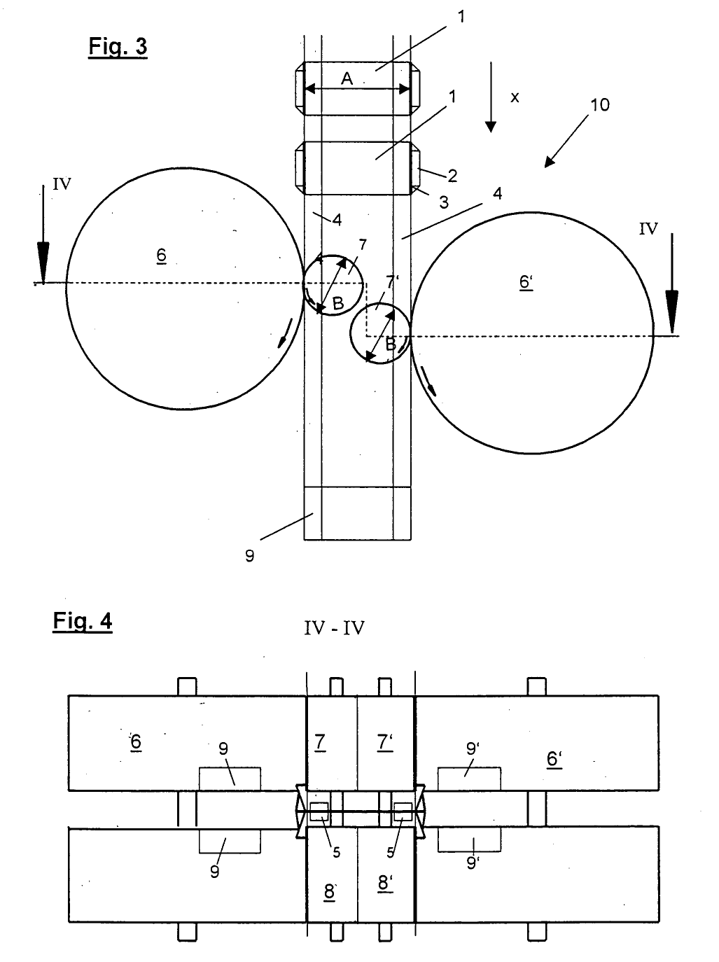

FIG. 3 Top view of a gluing station in a bottoming device according to the invention

FIG. 4 View of the section II-II in FIG. 3

FIG. 1 and FIG. 2 show a gluing station 10 in a bottoming device of common type. The tube segments 1 are conveyed tucked in the upper and the lower conveyor belts 4, 5. The tube segments 1 already exhibit the drawn up ends 2, and the corner folds 3 formed due to that, before the entry into the gluing station. On the outside of the conveyor belts 4, 5, the glue transfer rollers 6, 6′ are supported with the machine frame in a manner not shown here. The plane spanned by the axes of the glue transfer rollers 6, 6′ lies orthogonal to the direction of conveyance x of the tube segments. Above the conveyor belts 4, the upper counterpressure rollers 7, 7′ are supported, also in a manner not shown here. Similarly arranged are the counterpressure rollers 8, 8′ below the lower conveyor belt 5. The axes of all counterpressure rollers lie in the direction of transport x of the sacks at the same height. There lie also the axes of the glue transfer rollers. Now, if a tube segment 1 gets into the gluing station, the drawn up ends 2 are pressed into a right-angled position and at the same time the gluing format 9 is transferred onto the drawn up ends. Thereby, the drawn up ends 2 are pressed by the counterpressure rollers 7, 7′, 8, 8′, against the glue transfer rollers. With a bottoming device of this kind, only such tube segments can be used, whose mean bottom size A corresponds to the sum of the diameter B, B′ of the counterpressure rollers 7, 7′.

The gluing station shown in FIGS. 3 and 4 with the bottoming device according to the invention serves the purpose of manufacture of sacks with smaller mean bottom sizes. The tube segments 1, with their ends 2 drawn up with formation of corner folds 3, are conveyed by the conveyor belts 4, 5 in the direction of transport x. The rollers 6, 7, 8 and the rollers 6′, 7′, 8′ each form a function pair. The respective planes spanning the rollers 6, 7, 8 and the rollers 6′, 7′, 8′ are arranged with mutual displacement in the direction of transport x. The method of function of the gluing station corresponds to that shown in FIGS. 1 and 2. In the gluing station 10, the glue formats 9 and 9′ are conveyed with time lag onto the drawn up ends 2, whereby the gluing format 9′ is conveyed first. By means of the arrangement of the rollers, the tube segments 1, whose mean bottom size A is smaller than the diameters B, B′ of the counterpressure rollers 7, 7′, can be processed.

List of Reference Symbols

| | |
|---|---|
| 1 | Tube segment |
| 2 | Drawn up end |
| 3 | Corner fold |
| 4 | Upper conveyor belt |
| 5 | Lower conveyor belt |
| 6, 6′ | Glue transfer roller |
| 7, 7′ | Upper counterpressure roller |
| 8, 8′ | Lower counterpresure roller |
| 9, 9′ | Glue format |
| 10 | Gluing station |
| x | Direction of transport of the tube segments |
| A | Mean bottom size |
| B, B′ | Diameter of the counterpressure rollers 7, 7′ |

1. Bottoming device for cross bottom sacks, which are built from tube segments (1),
whereby the sacks pass through different processing stations in the bottoming device along the direction of transport (x) and
during the transport through the bottoming device, the axis of the tube segments (1) is oriented essentially horizontally as well as orthogonal to the direction of conveyance (x) of the tube segments (1) and
cross bottoms form at both the ends (2) of the tube segments (1),
whereby, during their gluing in one of the gluing stations (10) foreseen for that, the folded bottoms lie essentially orthogonal to the tube axis and
the glue transfer on both the folded cross bottoms takes place, under contact pressure from one of the glue transfer rollers (6, 6′)—which is often equipped with a format or a format block roller,
whereby this contact pressure is provided by counterpressure rollers (7, 7′, 8, 8′) which are provided in the gluing station (10) on the respective sides of the sack bottom lying opposite to the glue transfer rollers (6, 6′),
so that in each case, the respective glue transfer rollers (6, 6′) and counter pressure rollers (7, 7′, 8, 8′) form a function pair for the gluing of the folded cross bottoms
characterized in that
both the function pairs are mutually offset in the direction of the transport (x) of the sacks.

2. Bottoming device according to claim 1
characterized in that
the diameter (B, B′) of at least one of the two counterpressure rollers (7, 7′, 8, 8′) is greater than half of the mean bottom size of the sacks.

3. Bottoming device according to claim 2
characterized in that
the distance between the axes of the two function pairs in the direction of transport (x) of the sacks is smaller than 50 cm.
